(19) United States
(12) Patent Application Publication
(10) Pub. No.: US 2007/0264486 A1
(43) Pub. Date: Nov. 15, 2007

(54) Method of Producing a Catalyzed Particulate Filter and Filter Thus Obtained

(75) Inventor: Stephan Verdier, Rueil-Malmaison (FR)

Correspondence Address: Jean-Louis Seugnet;Rhodia Inc., 8 Cedar Brook Drive, CN 7500, Cranbury, NJ, 08512-7500, US

(73) Assignee: RHODIA CHIMIE, Aubervilliers (FR)

(21) Appl. No.: 11/662,532

(22) PCT Filed: Sep. 9, 2005
(86) PCT No.: PCT/FR05/02250

§ 371 Date: Mar. 9, 2007

(30) Foreign Application Priority Data
Sep. 15, 2004 (FR) 0409779

(51) Int. Cl. B01J 23/00; B32B 3/26

(52) U.S. Cl. 428/315.5; 502/304; 502/349

(57) ABSTRACT

The invention relates to a method of producing a catalysed particulate filter. The invention is characterised in that, in order to lower the particulate oxidation temperature, the filter is provided with a cerium oxide, a zirconium oxide or a cerium/zirconium mixed oxide which can also comprise at least one rare earth oxide other than cerium. The porosity of said oxide or mixed oxide is such that at least 80% of the pore volume comprises pores having a diameter of least 20 nm.

The present invention relates to a process for the manufacture of a catalyzed particulate filter and to the filter thus obtained.

During the combustion of fuels, carbon or hydrocarbon products form, in their combustion products, carbonaceous particles, also denoted in the continuation of the description under the expression of “soot”, which are supposed to be harmful, both to the environment and to the health. It is therefore necessary to reduce the emission of this soot.

The most commonly selected technique for this consists in fitting, to the exhaust systems, a particulate filter capable of halting all or a very high proportion of the carbonaceous particles generated by the combustion of the various fuels.

However, by gradually accumulating in the filters, the soot first brings about an increase in the pressure drop and, secondly, starts to form an obstruction, which results in a loss in performance of the engine. It is therefore necessary to incinerate the soot collected by these filters.

In order to facilitate the combustion of this soot, which combustion requires a temperature generally of at least 600° C., endeavors are being made, of course, to lower their ignition temperature. One solution proposed consists in incorporating an oxidation catalyst in the particulate filters. The term then used is “catalyzed particulate filter” (CPF). In this case, the ignition/oxidation temperature is reduced to approximately 550° C.

It is an object of the present invention to provide a CPF which makes it possible to obtain an oxidation temperature for the soot which is further lowered and which is generally less than 500° C.

With this aim and according to a first embodiment, the invention relates to a process for the manufacture of a catalyzed particulate filter, characterized in that, for the purpose of lowering the oxidation temperature of the particles, use is made, in order to incorporate it in the filter, of a cerium oxide or zirconium oxide having a porosity such that at least 80% of the pore volume is contributed by pores with a diameter at least equal to 20 nm.

According to another embodiment, the process of the invention is characterized in that, for the purpose of lowering the oxidation temperature of the particles, use is made, in order to incorporate it in the filter, of a mixed oxide of cerium and of zirconium having a porosity such that at least 80% of the pore volume is contributed by pores with a diameter at least equal to 20 nm.

According to a third embodiment, the process is characterized in that, for the purpose of lowering the oxidation temperature of the particles, use is made, in order to incorporate it in the filter, of a mixed oxide of cerium and of zirconium which additionally comprises at least one oxide of a rare earth element other than cerium, the porosity of this mixed oxide being such that at least 80% of the pore volume is contributed by pores with a diameter at least equal to 20 nm.

Finally, according to a fourth embodiment, the process is characterized in that, for the purpose of lowering the oxidation temperature of the particles, use is made, in order to incorporate it in the filter, of a mixed oxide of cerium and of zirconium which exhibits a Ce/Zr atomic ratio of at least 1 and which additionally comprises a praseodymium oxide, the porosity of this mixed oxide being such that at least 80% of the pore volume is contributed by pores with a diameter at least equal to 20 nm.

The invention is based on the demonstration of the importance of the nature of the pores and of the distribution of the latter. In particular, it appears advantageous to use products exhibiting mesopores (the term “mesopores” is understood here to mean pores with a size of between 2 and 100 nm) and having a size distribution included within a fairly wide range, for example a range with an amplitude of at least 10 nm in a differential porogram of the cumulative pore volume as a function of the logarithm of the size of the pores (dV/dlogD).

Other characteristics, details and advantages of the invention will become even more fully apparent on reading the description which will follow and various concrete but nonlimiting examples intended to illustrate it.

For the continuation of the description, the term “rare earth or lanthamide element” is understood to mean the elements from the group composed of yttrium and the elements of the Periodic Table with an atomic number of between 57 and 71 inclusive.

It is also specified that, unless otherwise indicated, in the ranges of values which are given, the values at the limits are included. The contents of elements in the compositions are given, unless otherwise indicated, as weight of oxide with respect to the weight of the whole of the composition.

The porosities indicated in the present description are measured by mercury intrusion porosimetry in accordance with standard ASTM D 4284-03 (Standard method for determining pore volume distribution of catalysts by mercury intrusion porosimetry). These porosity characteristics have to be confirmed for products which have been subjected to a calcination at temperatures which can be between 600° C. and 1000° C.

The term “specific surface” is understood to mean the BET specific surface determined by nitrogen adsorption in accordance with standard ASTM D 3663-78, drawn up from the Brunauer—Emmett—Teller method described in the journal “The Journal of the American Chemical Society, 60, 309 (1938)”.

As indicated above, the process of the invention can be carried out according to different embodiments.

Use may be made of a cerium oxide (CeO₂) or a zirconium oxide (ZrO₂). Use may also be made of a mixed oxide. The term “mixed oxide” is understood here to mean a composition or a mixture of at least two oxides, it being possible for this composition optionally to exist in the form of a solid solution of the other oxide or oxides in a first oxide. The X-ray diffraction diagrams of such a composition reveal, in this case, within the composition, the existence of a single pure or homogeneous phase.

In the case of a solid solution of one or more oxides in the cerium oxide, this phase corresponds in fact to a crystalline structure of fluorine type, just like crystalline ceric oxide CeO₂, having unit cell parameters more or less offset with respect to a pure ceric oxide, thus reflecting the incorporation of the zirconium and, if appropriate, of the other rare earth element in the crystal lattice of the cerium oxide and thus the production of a true solid solution.

In the case of a solid solution of one or more oxides in the zirconium oxide, the X-ray diffraction diagrams of these compositions then reveal a single phase corresponding to that of a zirconium oxide crystallized in the tetragonal system, thus reflecting the incorporation of the cerium and of the other element in the crystal lattice of the zirconium oxide.

In the case of the mixed oxides, use may be made of a composition based on the two oxides of cerium and of zirconium alone. In this case, the Ce/Zr atomic ratio is preferably at least 1, which corresponds to a proportion by weight of cerium oxide with respect to the whole of the composition of at least 58%.

Use may also be made, as mixed oxide, of a composition based on cerium oxide, on zirconium oxide and on at least one oxide of a rare earth element other than cerium. They are thus, in this case, compositions which comprise at least three oxides. The rare earth element other than cerium can be chosen in particular from yttrium, lanthanum, neodymium and praseodymium and their combination. Praseodymium can be very particularly used.

The content of oxide of the rare earth element other than cerium is generally at most 35% by weight. Preferably, it is at least 1%, more particularly at least 5% and more particularly still at least 10% and it can be between 25% and 30%.

In the case of the compositions based on three oxides or more, the Ce/Zr atomic ratio can be, here also preferably, at least 1.

Mention may be made, as one of the preferred embodiments, of the use of a mixed oxide of cerium and of zirconium which exhibits a Ce/Zr atomic ratio of at least 1 and which additionally comprises a praseodymium oxide. In the latter case, the content of praseodymium oxide can be at least 10%. It can thus be between 10% and 35%, more particularly between 25% and 35% and more particularly still between 30% and 35%.

Other more specific embodiments can also be described.

Thus, use may be made of a mixed oxide which exhibits a Zr/Ce atomic ratio of at least 1 and which comprises a lanthanum oxide and a neodymium oxide. In this case, the overall proportion of lanthanum and neodymium oxides can correspond to the values which were given above for the content of oxide of the rare earth element other than cerium.

Use may also be made of a zirconium oxide which additionally comprises an additive chosen from yttrium, praseodymium, lanthanum or neodymium oxides. Praseodymium is preferred.

In this case, the content of additive is generally at most 50% by weight of oxide of additive with respect to the weight of the composition and it can be between 10% and 40%.

According to alternative forms of the invention, the oxides or the mixed oxides used can more particularly exhibit a porosity such that at least 85% of the pore volume is contributed by pores with a diameter at least equal to 20 nm.

Furthermore, the oxides or the mixed oxides used can more particularly exhibit a distribution in the pores such that the pore volume contributed by the pores having a diameter of between 20 nm and 100 nm constitutes at least 10%, more particularly at least 15% and more particularly still at least 30% of the total pore volume.

The oxides which can be used in the context of the invention must exhibit a specific surface suitable for the type of use considered here, that is to say that they must exhibit surface areas which are sufficiently high to be able to catalyze the combustion of the soot and these surface areas must remain at an acceptable level when the filter is exposed to the temperatures of the exhaust gases. By way of example, this surface area should preferably be at least 20 m²/g after calcination of the oxide at a temperature of 800° C. for 6 hours.

A process and its various alternative forms for the preparation of oxides which are suitable for the present invention are given below, by way of examples.

Generally, this process comprises the following stages:
(a) a medium comprising a cerium compound, a zirconium compound and/or optionally a compound of the other rare earth element is formed;
(b) said medium is brought into contact with a basic compound, whereby a precipitate is obtained;
(c) said precipitate is heated in an aqueous medium; then
(d) either an additive, chosen from anionic surfactants, nonionic surfactants, polyethylene glycols, carboxylic acids and their salts and surfactants of the type of carboxymethylated ethoxylates of fatty alcohols, is first added to the medium resulting from the preceding stage and said precipitate is then optionally separated;
(d′) or said precipitate is first separated and said additive is then added to the precipitate;
(e) the precipitate thus obtained is calcined.

The first stage consists in preparing a starting medium which is generally a liquid medium, preferably water, comprising a compound of the element or elements cerium, zirconium or rare earth element other than cerium which participates in the composition of the oxide which it is desired to prepare.

The compounds are preferably soluble compounds. They can in particular be zirconium, cerium and lanthamide salts. These compounds can be chosen from nitrates, sulfates, acetates, chlorides, ceric ammonium nitrates.

Mention may thus be made, as examples, of zirconium sulfate, zirconyl nitrate or zirconyl chloride. Use is most generally made of zirconyl nitrate. Mention may also be made in particular of cerium(IV) salts, such as nitrates or ceric ammonium nitrates, for example, which are particularly well suited here. Ceric nitrate can be used. It is advantageous to use salts with a purity of at least 99.5% and more particularly of at least 99.9%. An aqueous ceric nitrate solution can, for example, be obtained by reaction of nitric acid with a ceric oxide hydrate prepared conventionally by reaction of a solution of a cereus salt, for example cereus nitrate, and of an aqueous ammonia solution in the presence of aqueous hydrogen peroxide solution. Use may also in particular be made of a ceric nitrate solution obtained according to the process for the electrolytic oxidation of a cereus nitrate solution, such as disclosed in the document FR-A-2 570 087, which in this instance constitutes an advantageous starting material.

It should be noted here that the aqueous solutions of cerium salts and of zirconyl salts can exhibit a degree of initial free acidity which can be adjusted by addition of a base or of an acid. However, it is just as possible to employ an initial solution of cerium and zirconium salts effectively exhibiting a degree of free acidity as mentioned above as solutions which will have been neutralized beforehand more or less exhaustively. This neutralization can be carried out by addition of a basic compound to the abovementioned medium so as to limit this acidity. This basic compound can, for example, be an aqueous ammonia solution or alternatively a solution of alkali metal (sodium, potassium, and the like) hydroxides but preferably an aqueous ammonia solution.

Finally, it should be noted that, when the starting medium comprises a cerium compound in which the latter is in the form of Ce(III), it is preferable to involve an oxidizing agent, for example aqueous hydrogen peroxide solution, in the course of the process. This oxidizing agent can be used by being added to the reaction medium during stage (a) or during stage (b), in particular at the end of the latter.

It is also possible to use a sol as starting zirconium or cerium compound. The term “sol” denotes any system composed of fine solid particles of colloidal dimensions, that is to say dimensions of between approximately 1 nm and approximately 500 nm, based on a zirconium or cerium compound, this compound generally being a zirconium or cerium oxide and/or oxide hydrate, in suspension in an aqueous liquid phase, it being possible in addition for said particles optionally to comprise residual amounts of bonded or adsorbed ions, such as, for example, nitrates, acetates, chlorides or ammoniums. It should be noted that, in such a sol, the zirconium or the cerium may be found either entirely in the form of colloids or simultaneously in the form of ions and in the form of colloids.

The starting medium can be obtained without distinction either from compounds initially in the solid state which will be subsequently introduced into an aqueous vessel heel, for example, or alternatively directly from solutions of these compounds and then mixing said solutions in any order.

In the second stage (b) of the process, said medium is brought into contact with a basic compound. This contacting operation results in the formation of a precipitate. Products of the hydroxide type can be used as base or basic compound. Mention may be made of alkali metal or alkaline earth metal hydroxides. Use may also be made of secondary, tertiary or quaternary amines. However, amines and aqueous ammonia may be preferred insofar as they reduce the risk of pollution by alkali metal or alkaline earth metal cations. Mention may also be made of urea. The basic compound is generally used in the form of an aqueous solution.

The way in which the starting medium and the solution are brought into contact, that is to say the order of introduction of these, is not critical. However, this contacting operation can be carried out by introducing the medium into the solution of the basic compound. It is preferable to proceed in this way in order to obtain the compositions in the form of solid solutions.

The contacting operation or the reaction between the starting medium and the solution, in particular the addition of the starting medium to the solution of the basic compound, can be carried out all at once, gradually or continuously, and it is preferably carried out with stirring. It is preferably carried out at ambient temperature.

The following stage (c) of the process is the stage of heating the precipitate in an aqueous medium.

This heating can be carried out directly on the reaction medium obtained after reaction with the basic compound or on a suspension obtained after separation of the precipitate from the reaction medium, optional washing and resuspending in water of the precipitate. The temperature at which the medium is heated is at least 100° C. and more particularly still at least 130° C. The heating operation can be carried out by introducing the liquid medium into an enclosed space (closed reactor of the autoclave type). Under the temperature conditions given above, and in an aqueous medium, it may be specified, by way of illustration, that the pressure in the closed reactor can vary between a value of greater than 1 bar (10⁵ Pa) and 165 bar (1.65×10⁷ Pa), preferably between 5 bar (5×10⁵ Pa) and 165 bar (1.65×10⁷ Pa). The heating can also be carried out in an open reactor for temperatures in the region of 100° C.

The heating can be carried out either under air or under an inert gas atmosphere, preferably nitrogen.

The duration of the heating can vary within wide limits, for example between 10 minutes and 48 hours, preferably between 2 and 24 hours. Likewise, the rise in temperature is carried out at a rate which is not critical and it is thus possible to reach the reaction temperature set by heating the medium, for example, for between 30 minutes and 4 hours, these values being given entirely by way of indication. According to an alternative form of the process, a heating operation is carried out at 100° C. over a period of time of between 10 minutes and one hour. According to another alternative form, this heating operation is carried out at 150° C. over a period of time of between 1 and 3 hours.

The medium subjected to the heating operation generally exhibits a pH of at least 5. Preferably, this pH is basic, that is to say that it is greater than 7 and more particularly at least 8.

It is possible to carry out several heating operations. Thus, the precipitate obtained after the heating stage and optionally a washing operation can be resuspended in water and then another heating operation can be carried out on the medium thus obtained. This other heating operation is carried out under the same conditions as those which have been described for the first.

The following stage of the process can be carried out according to two embodiments.

According to a first embodiment, an additive which is chosen from anionic surfactants, nonionic surfactants, polyethylene glycols, carboxylic acids and their salts and surfactants of the type of carboxymethylated ethoxylates of fatty alcohols is added to the reaction medium resulting from the preceding stage (c). As regards this additive, reference may be made to the teaching of application WO 98/45212 and use may be made of the surfactants disclosed in this document.

Mention may be made, as surfactants of the anionic type, of ethoxycarboxylates, ethoxylated or propoxylated fatty acids, in particular those of the Alkamuls® brand, sarcosinates of formula R—C(O)N(CH₃)CH₂COO⁻, betaines of formula RR′NH—CH₃—COO⁻, R and R′ being alkyl or alkylaryl groups, phosphate esters, in particular those of the Rhodafac® brand, sulfates, such as alcohol sulfates, alcohol ether sulfates and sulfated alkanolamide ethoxylates, sulfonates, such as sulfosuccinates, alkylbenzenesulfonates or alkylnaphthalenesulfonates.

Mention may be made, as nonionic surfactants, of acetylenic surfactants, ethoxylated or propoxylated fatty alcohols, for example those of the Rhodasurf® or Antarox® brands, alkanolamides, amine oxides, ethoxylated alkanolamides, long-chain ethoxylated or propoxylated amines, for example those of the Rhodameen® brand, ethylene oxide/propylene oxide copolymers, sorbitan derivatives, ethylene glycol, propylene glycol, glycerol, polyglyceryl esters and their ethoxylated derivatives, alkylamines, alkylimidazolines, ethoxylated oils and ethoxylated or propoxylated alkylphenols, in particular those of the Igepal® brand. Mention may also in particular be made of the products cited in WO 98/45212 under the Igepal®, Dowanol®, Rhodamox® and Alkamide® brands.

As regards the carboxylic acids, use may in particular be made of aliphatic mono- or dicarboxylic acids and, among these, more particularly of saturated acids. Use may also be made of fatty acids and more particularly of saturated fatty acids. Mention may thus in particular be made of formic, acetic, propionic, butyric, isobutyric, valeric, caproic, caprylic, capric, lauric, myristic, palmitic, stearic, hydroxystearic, 2-ethylhexanoic and behenic acids. Mention may be made, as dicarboxylic acids, of oxalic, malonic, succinic, glutaric, adipic, pimelic, suberic, azelaic and sebacic acids.

The salts of the carboxylic acids can also be used.

Finally, it is possible to use a surfactant which is chosen from those of the carboxymethylated ethoxylates of fatty alcohols type.

The term “product of the carboxymethylated ethoxylates of fatty alcohols type” is understood to mean products composed of ethoxylated or propoxylated fatty alcohols comprising a CH₂—COOH group at the chain end.

These products can correspond to the formula:
R₁—O—(CR₂R₃—CR₄R₅—O)ₙ—CH₂—COOH
in which R₁ denotes a saturated or unsaturated carbon chain, the length of which is generally at most 22 carbon atoms, preferably at least 12 carbon atoms; R₂, R₃, R₄ and R₅ can be identical and represent hydrogen or alternatively R₂ can represent a CH₃ group and R₃, R₄ and R₅ represent hydrogen; n is a nonzero integer which can range up to 50 and more particularly of between 5 and 15, these values being inclusive. It should be noted that a surfactant can be composed of a mixture of products of the above formula for which R₁ can be saturated or unsaturated respectively or alternatively products comprising both —CH₂—CH₂—O— and —CH(CH₃)—CH₂—O— groups.

After the addition of the surfactant, the precipitate is optionally separated from the liquid medium by any known means.

Another embodiment consists in first separating the precipitate resulting from stage (c) and then adding the surfactant additive to this precipitate.

The amount of surfactant used, expressed as percentage by weight of additive with respect to the weight of the composition, calculated as oxide, is generally between 5% and 100%, more particularly between 15% and 60%.

In a final stage of the process, the precipitate recovered is subsequently calcined. This calcination makes it possible to develop the crystallinity of the product formed and it can also be adjusted and/or chosen according to the subsequent operating temperature reserved for the composition according to the invention, this being done while taking into account the fact that the specific surface of the product becomes smaller as the calcination temperature employed becomes higher.

In practice, the calcination temperature is generally limited to a range of values of between 300 and 1000° C.

Such a calcination is generally carried out under air.

The general process which has been described above can form the subject of several alternative forms.

First of all, and according to a first alternative form, the first stage (a) of the process is identical to that described above and thus that which has been described above on this subject likewise applies here.

The second stage of the process, stage (b′), is a stage in which the medium or mixture resulting from the first stage is heated. The temperature at which this heating operation or heat treatment, also referred to as thermal hydrolysis, is carried out can be between 80° C. and the critical temperature of the reaction medium, in particular between 80 and 350° C., preferably between 90 and 200° C.

This treatment can be carried out, depending on the temperature conditions selected, either at standard atmospheric pressure or under pressure, such as, for example, the saturated vapor pressure corresponding to the temperature of the heat treatment. When the treatment temperature is chosen to be greater than the reflux temperature of the reaction mixture (that is to say, generally greater than 100° C.), for example chosen between 150° C. and 350° C., the operation is then carried by introducing the liquid mixture comprising the abovementioned entities into an enclosed space (closed reactor, more commonly referred to as autoclave), the necessary pressure then resulting only from the heating alone of the reaction medium (autogenous pressure). Under the temperature conditions given above, and in aqueous media, it may thus be specified, by way of illustration, that the pressure in the closed reactor varies between a value of greater than 1 bar (10⁵ Pa) and 165 bar (165×10⁵ Pa), preferably between 5 bar (5×10⁵ Pa) and 165 bar (165×10⁵ Pa). It is, of course, also possible to exert an external pressure which is then added to that resulting from the heating.

The heating can be carried out under an atmosphere of air or under an atmosphere of inert gas, preferably nitrogen.

The duration of the treatment is not critical and can thus vary within wide limits, for example between 10 minutes and 48 hours, preferably between 2 and 24 hours.

On conclusion of the heating stage, a solid precipitate is recovered which can be separated from its medium by any conventional solid/liquid separating technique, such as, for example, filtration, settling, draining or centrifuging.

It can be advantageous to introduce a base, such as, for example, an aqueous ammonia solution, into the precipitation medium after the heating stage. This makes it possible to increase the yields for recovery of the precipitated entity.

The following stages of the process are identical respectively to stages (d), (d′) and (e) described above and, here again, that which was described above on this subject likewise applies.

According to a second alternative form, the process comprises, before the calcination stage, a milling of the precipitate resulting from stage (d) or from stage (d′).

This milling can be carried out in different ways.

A first way consists in carrying out a high-energy milling of the wet-milling type. Such a milling is carried out on the wet precipitate which has been obtained either on conclusion of stage (d′) or on conclusion of stage (d), in the case where this precipitate has indeed been separated from its original liquid medium. The wet milling can be carried out in a bead mill, for example.

A second way consists in carrying out a medium-energy milling by subjecting a suspension of the precipitate to shearing, for example using a colloid mill or a rotor agitator. This suspension can be an aqueous suspension which has been obtained after redispersing in water the precipitate obtained on conclusion of stages (d) or (d′). It can also be the suspension directly obtained at the end of stage (d) after the addition of the surfactant without there having been separation of the precipitate from the liquid medium.

On conclusion of the milling, the product obtained can optionally be dried, for example by passing through an oven.

Finally, according to a final alternative form, the calcination can be carried out in two steps.

In a first step, the calcination is carried out under an inert gas or under vacuum. The inert gas can be helium, argon or nitrogen. The vacuum is generally a low vacuum with a partial oxygen pressure of less than 10⁻¹ mbar. The calcination temperature can be between 800° C. and 1000° C. The duration of this first calcination is generally at least 1 hour, more particularly at least 4 hours and in particular at least 6 hours. Of course, the duration can be set according to the temperature, a short calcination time requiring a higher temperature.

In a second step, a second calcination is carried out under an oxidizing atmosphere, for example under air. In this case, the calcination is generally carried out at a temperature of at least 300° C. over a period of time which is generally at least 30 minutes. A temperature of less than 300° C. can make it difficult to remove the additives used during stages (d) or (d′) described above. It is preferable not to exceed a calcination temperature of 900° C.

Finally, the alternative forms of the process which are described above can be combined with one another.

By way of example, the mixed oxides of cerium and of zirconium with the Ce/Zr atomic ratio of at least 1 can be prepared more particularly by the general process described above or by the process alternative form employing a milling and two-step calcination as described above. Likewise, and still by way of example, the mixed oxide which exhibits a Zr/Ce atomic ratio of at least 1 and which comprises a lanthanum oxide and a neodymium oxide can be prepared by the process employing a milling and calcination, either under air or in two steps. The zirconium oxide which additionally comprises an additive, such as praseodymium oxide, can be prepared in particular by the general process.

The process for the manufacture of the CPFs according to the invention applies to all the filters of this type, of conventional shape and of conventional structure. Conventionally, these filters are provided in the form of metal monoliths comprising one or more sieves made of metal mesh through which the exhaust gases move or of ceramic monoliths, for example with a filtering ceramic wall or of the ceramic foam type. The ceramic can be a mullite or a mullite-cordierite, in particular. The monolith can also be made of silicon carbide.

The process of the invention consists in incorporating the oxide or mixed oxide described above in the filter, for example by coating. In this case, a suspension of the oxide or of the mixed oxide in an aqueous medium comprising a binder of the alumina, silica or titanium oxide type is formed and the filter is charged with this suspension. The coating is carried out so as to bring about the penetration of the suspension into the walls of the filter without a film, of the wash coat type, being formed on these walls. For the implementation of the process of the invention, it may be advisable to mill the oxide or the mixed oxide, for example to a particle size of approximately 0.5 μm to 1.5 μm, in particular in order to obtain a suspension for the coating which is homogeneous. The oxide or the mixed oxide must exhibit, on conclusion of this milling, a porosity of the same type as that which has been described above for the oxides before milling.

The oxide or the mixed oxide can be employed in combination with precious metals. The nature of these metals and the techniques for incorporating them, in particular by impregnation, are well known to a person skilled in the art. For example, the metals can be platinum, rhodium, palladium or iridium.

The invention also relates to a catalyzed particulate filter as obtained by the process described above. The invention thus also covers a filter which comprises an oxide which can be a cerium oxide or a zirconium oxide or a mixed oxide of cerium and of zirconium optionally comprising a rare earth element and which has a porosity such that at least 80% of the pore volume is contributed by pores with a diameter at least equal to 20 nm. Everything which has been mentioned above in the description of the process with regard to the nature of the oxide and to its porosity likewise applies here to the description of the filter.

Examples will now be given.

In these examples, the porosity of the materials is characterized by mercury intrusion porosimetry using a device of Autopore III 9420 type from Micromeritics in accordance with standard ASTM D 4284-03 mentioned above.

Examples 1 to 7 describe the preparation of compositions and example 8 gives the performance of these compositions in a soot oxidation test.

### EXAMPLE 1

This example relates to the preparation of a composition based on oxides of cerium and of zirconium in the respective proportions by weight of oxide of 58% and 42% and which exhibits the characteristics according to the invention.

525 ml of zirconium nitrate (80 g/l) and 245 ml of ceric nitrate solution (Ce⁴⁺=236.5 g/l, Ce³⁺=15.5 g/l and free acidity=0.7 N) are introduced into a stirred beaker. The volume is subsequently made up with distilled water so as to obtain 1 liter of a solution of nitrates.

253 ml of an aqueous ammonia solution are introduced into a stirred reactor and the volume is subsequently made up with distilled water so as to obtain a total volume of 1 liter.

The solution of nitrates is introduced in one hour into the reactor with constant stirring.

The solution obtained is placed in a stainless steel autoclave equipped with a stirrer. The temperature of the medium is brought to 150° C. for 2 hours with stirring.

The suspension thus obtained is then filtered on a Büchner funnel. A precipitate comprising 23.4% by weight of oxide is recovered.

100 g of this precipitate are withdrawn.

At the same time, an ammonium laurate gel was prepared under the following conditions: 250 g of lauric acid are introduced into 135 ml of aqueous ammonia (12 mol/l) and 500 ml of distilled water and then the mixture is homogenized using a spatula.

28 g of this gel are added to 100 g of the precipitate and then the combined product is kneaded until a homogeneous paste is obtained.

The product obtained is subsequently brought to 650° C. under air for 2 hours under stationary conditions.

The surface areas obtained after subsequent calcinations at different temperatures are shown below.
4 h 700° C.=74 m²/g
4 h 900° C.=49 m²/g
4 h 1000° C.=31 m²/g

### EXAMPLE 2 (Comparative)

This example relates to the preparation of a composition based on oxides of cerium and of zirconium in the respective proportions by weight of oxide of 58% and 42% and which does not exhibit the porosity characteristics according to the invention.

The starting solution is composed of a mixture of cerium(IV) nitrate and of zirconium nitrate in respective proportions by weight of oxide of 58% and 42%.

The zirconium solution is obtained by treating a zirconium carbonate using concentrated nitric acid. This solution is such that the amount of base necessary to achieve the equivalent point during an acid/base quantitative determination of this solution confirms the condition of an OH⁻/Zr molar ratio of 0.85.

The acid/base quantitative determination is carried out in a known way. In order to carry it out under optimum conditions, a solution which has been brought to a concentration of approximately 3×10⁻² mol per liter, expressed as zirconium element, can be quantitatively determined. A 1 N sodium hydroxide solution is added thereto with stirring. Under these conditions, the determination of the equivalent point (change in the pH of the solution) is carried out in a clear-cut fashion. This equivalent point is expressed by the OH⁻/Zr molar ratio.

The concentration of this mixture (expressed as oxide of the various elements) is adjusted to 80 g/l. This mixture is subsequently brought to 150° C. for 4 hours.

An aqueous ammonia solution is subsequently added to the reaction medium so that the pH is greater than 8.5. The reaction medium thus obtained is brought to reflux for 2 hours. After separation by settling and then drawing off, the solid product is resuspended and the medium thus obtained is treated at 100° C. for 1 hour. The product is subsequently filtered off and then calcined at 650° C. for 2 hours under air.

The surface areas obtained after subsequent calcinations at different temperatures are shown below.
4 h 700° C.=82 m²/g
4 h 900° C.=45 m²/g
4 h 1000° C.=24 m²/g

### EXAMPLE 3

This example relates to the preparation of a composition based on oxides of cerium, of zirconium, of lanthanum and of neodymium in the respective proportions by weight of oxide of 21%, 72%, 2% and 5% and which exhibits the characteristics according to the invention.

900 ml of zirconium nitrate (80 g/l), 42.3 ml of cerium(III) nitrate (496 g/l), 4.4 ml of lanthanum nitrate (454 g/l) and 9.5 ml of neodymium nitrate (524 g/l) are introduced into a stirred beaker. The mixture is subsequently made up to volume with distilled water so as to obtain 1 liter of a solution of these nitrates.

250 ml of an aqueous ammonia solution (12 mol/l) and 74 ml of aqueous hydrogen peroxide solution (110 volumes) are introduced into a stirred reactor and the mixture is subsequently made up to volume with distilled water so as to obtain a total volume of 1 liter.

The solution of nitrates is introduced into the reactor in one hour with constant stirring so as to obtain a suspension.

The suspension obtained is placed in a stainless steel autoclave equipped with a stirrer. The temperature of the medium is brought to 150° C. for 2 hours with stirring.

The suspension thus obtained is then filtered on a Büchner funnel. A precipitate with a pale yellow color comprising 20% by weight of oxide is recovered.

76 g of this precipitate are withdrawn and placed in a bead mill (Molinex PE 075 from Netzsch).

At the same time, an ammonium laurate gel was prepared under the following conditions: 250 g of lauric acid are introduced into 135 ml of aqueous ammonia (12 mol/l) and 500 ml of distilled water and then the mixture is homogenized using a spatula.

24 g of this gel are added to the precipitate in the bead mill. The mixture is made up to volume with 100 ml of distilled water and 250 ml of zirconia beads (diameter of between 0.4 and 0.7 mm). The combined product is milled at 1500 rev/min for 60 minutes.

The precipitate is subsequently washed on a sieve in order to recover the milling beads. The suspension obtained is then dried in an oven at 60° C. for 24 hours. The dried product is subsequently brought to 900° C. under air for 4 hours under stationary conditions.

The surface areas obtained after subsequent calcinations at different temperatures are shown below.
4 h 900° C.=52 m²/g
4 h 1000° C.=40 m²/g

### EXAMPLE 4 (Comparative)

The example relates to the preparation of a composition based on oxides of cerium, of zirconium, of lanthanum and of neodymium in the respective proportions by weight of oxide of 21%, 72%, 2% and 5% and which does not exhibit the porosity characteristics according to the invention.

A ceric nitrate solution, a lanthanum nitrate solution, a praseodymium nitrate solution and a zirconium nitrate solution are mixed in the stoichiometric proportions required in order to obtain the above mixed oxide. The zirconium nitrate solution corresponds, in the sense defined in example 2, to the condition of an OH⁻/Zr molar ratio of 1.17.

The procedure subsequently followed is identical to that of example 2.

The surface areas obtained after subsequent calcinations at different temperatures are shown below.
4 h 700° C.=91 m²/g
4 h 900° C.=68 m²/g
4 h 1000° C.=44 m²/g

### EXAMPLE 5

This example relates to the preparation of a composition based on oxides of cerium, of zirconium and of praseodymium in the respective proportions by weight of oxide of 55%, 15% and 30% and which exhibits the characteristics according to the invention.

47 g of zirconium nitrate solution (270 g/l, expressed as oxide), 122 g of cerium(III) nitrate solution (496 g/l, expressed as oxide) and 113 g of praseodymium nitrate solution (303 g/l, expressed as oxide) are introduced into a stirred beaker. The mixture is subsequently made up to volume with distilled water so as to obtain 400 ml of a solution of the cerium, zirconium, lanthanum and neodymium salts.

137 ml of an aqueous ammonia solution (14.8 mol/l) and 125 ml of 30% aqueous hydrogen peroxide solution (9.8 mol/l) are introduced into a stirred reactor and the mixture is subsequently made up to volume with distilled water so as to obtain a total volume of 400 ml.

The solution of cerium, zirconium and praseodymium salts is gradually introduced into the reactor with constant stirring. The solution is subsequently brought to 100° C. for 15 minutes.

After cooling, the suspension thus obtained is then filtered off on a Büchner funnel. A precipitate with a pale yellow color comprising 21% by weight of oxide is recovered.

50 g of this precipitate are withdrawn.

At the same time, an ammonium laurate gel was prepared under the following conditions: 250 g of lauric acid are introduced into 135 ml of aqueous ammonia (12 mol/l) and 500 ml of distilled water and then the mixture is homogenized using a spatula.

14 g of this gel are added to 50 g of the precipitate and then the combined product is kneaded until a homogeneous paste is obtained.

The product obtained is subsequently brought to 650° C. under air for 2 hours under stationary conditions.

The surface areas obtained after subsequent calcinations at different temperatures are shown below.
4 h 700° C.=75 m²/g
4 h 900° C.=39 m²/g
4 h 1000° C.=24 m²/g

### EXAMPLE 6 (Comparative)

This example relates to the preparation of a composition based on oxides of cerium, of zirconium and of praseodymium in the respective proportions by weight of oxide of 55%, 15% and 30% and which does not exhibit the porosity characteristics according to the invention.

A ceric nitrate solution, a praseodymium nitrate solution and a zirconium nitrate solution are mixed in the stoichiometric proportions required in order to obtain the above mixed oxide. The zirconium nitrate solution corresponds, in the sense defined in example 2, to the condition of an OH⁻/Zr molar ratio of 1.14.

The procedure subsequently followed is identical to that of example 2.

The surface areas obtained after subsequent calcinations at different temperatures are shown below.
4 h 700° C.=80 m²/g
4 h 900° C.=33 m²/g
4 h 1000° C.=17 m²/g

### EXAMPLE 7

This example relates to the preparation of a composition comprising 90% of zirconium and 10% of praseodymium, these proportions being expressed as percentages by weight of the oxides ZrO₂ and Pr₆O₁₁, and which exhibits the characteristics according to the invention.

750 ml of zirconium nitrate (120 g/l) and 20 ml of praseodymium nitrate (500 g/l) are introduced into a stirred beaker. The mixture is subsequently made up to volume with distilled water so as to obtain 1 liter of a solution of conitrate.

220 ml of an aqueous ammonia solution (12 mol/l) are introduced into a stirred reactor and the mixture is subsequently made up to volume with distilled water so as to obtain a total volume of 1 liter.

The conitrate solution is introduced in one hour into the reactor with constant stirring.

The solution obtained is placed in a stainless steel autoclave equipped with a stirrer. The temperature of the medium is brought to 150° C. for 2 hours with stirring.

The suspension thus obtained is then filtered on a Büchner funnel. A precipitate comprising 18% by weight of oxide is recovered.

100 g of this precipitate are withdrawn.

At the same time, an ammonium laurate gel was prepared under the following conditions: 250 g of lauric acid are introduced into 135 ml of aqueous ammonia (12 mol/l) and 500 ml of distilled water and then the mixture is homogenized using a spatula.

21.5 g of this gel are added to 100 g of the precipitate and then the combined product is kneaded until a homogeneous paste is obtained.

The product obtained is subsequently brought to 500° C. for 4 hours under stationary conditions.

The surface areas obtained after subsequent calcinations at different temperatures are shown below.
4 h 700° C.=64 m²/g
4 h 900° C.=59 m²/g
10 h 1000° C.=40 m²/g

### EXAMPLE 8

This example relates to a test on the catalytic oxidation of soot.

The catalytic properties for the oxidation of soot are measured by thermogravimetric analysis. Use is made of a Setaram thermal balance equipped with a quartz boat in which a 20 mg sample is placed.

The sample is composed of a mixture of catalytic powder based on a composition according to the preceding examples and a carbon black in respective proportions by weight of 80% and 20%. The catalytic powder is calcined beforehand at 700° C. or 900° C. for 4 h. The carbon black used to simulate the soot emitted by a diesel combustion engine is carbon black from Cabot referenced Elftex 125. The mixture of catalytic powder and carbon black is prepared by manual grinding with a pestle and mortar for 5 minutes.

20 mg of this mixture are introduced into the quartz boat and then the gas stream, composed of an air/water mixture in respective proportions by volume of 87% and 13%, is passed across. After a stationary phase at 150° C. for 30 minutes, the temperature is increased with a gradient of 10° C./min up to 900° C. The loss in weight of the sample is measured as a function of the temperature.

The following table 1 shows, for each example, the total pore volume (TPV), the fraction of the total pore volume relating to pores having a size of greater than 20 nm (% Vp^{>20} nm) and, in the “% of the TPV 20-100 nm” column, the percentage of the total pore volume which is contributed by the pores having a diameter of between 20 nm and 100 nm. The values for porosity correspond to that measured on the products which have been subjected to a calcination under the temperature and duration conditions shown in the table.

The results of the test are given in table 2. They are expressed as temperature for semi-oxidation of the soot (T_{50%} (soot)), corresponding to the temperature at which half of the loss in weight measured between 200° C. and 900° C. is obtained.

TABLE 1

| | | BET | Total pore | | |
|---|---|---|---|---|---|
| | | surface | volume | Porosity | % of the |
| | | area | (TPV) | % | TPV |
| Example | Calcination | (m²/g) | (ml/g) | Vp^{>20 nm} | 20-100 nm |
| 1 | 900° C./4 h | 49 | 0.90 | 86% | 35% |
| 2, | 900° C./4 h | 45 | 0.58 | 58% | 2% |
| comparative | | | | | |
| 3 | 900° C./4 h | 52 | 1.40 | 85% | 32% |
| 4, | 900° C./4 h | 68 | 0.70 | 56% | 3% |
| comparative | | | | | |
| 5 | 700° C./4 h | 75 | 0.97 | 89% | 17% |
| 6, | 700° C./4 h | 80 | 0.43 | 68% | 1% |
| comparative | | | | | |
| 7 | 700° C./4 h | 64 | 1.31 | 84% | 27% |

TABLE 2

| Example | T_{50%}(soot) in ° C. |
|---|---|
| 1 | 405 |
| 2, comparative | 450 |
| 3, | 440 |
| 4, comparative | 530 |
| 5 | 390 |
| 6, comparative | 445 |
| 7 | 490 |

A marked reduction in the temperature for oxidation of the soot can be seen from table 2 for the compositions according to the invention.

1-12. (canceled)

13. A process for the manufacture of a catalyzed particulate filter, for the purpose of lowering the oxidation temperature of the particles of said filter, comprising the step of incorporating a cerium oxide or zirconium in the filter, said oxide having a porosity such that at least 80% of the pore volume is contributed by pores with a diameter at least equal to 20 nm.

14. The process for the manufacture of a catalyzed particulate filter, for the purpose of lowering the oxidation temperature of the particles of said filter, comprising the step of incorporating a mixed oxide of cerium and of zirconium in the filter, said mixed oxide having a porosity such that at least 80% of the pore volume is contributed by pores with a diameter at least equal to 20 nm.

15. The process according to claim 14, wherein the mixed oxide of cerium and of zirconium further comprises at least one oxide of a rare earth element other than cerium, the porosity of this mixed oxide being such that at least 80% of the pore volume is contributed by pores with a diameter at least equal to 20 nm.

16. The process as claimed in claim 14, wherein the mixed oxide exhibits a Ce/Zr atomic ratio of at least 1.

17. The process as claimed in claim 15, wherein the mixed oxide exhibits a Ce/Zr atomic ratio of at least 1.

18. The process as claimed in claim 14, wherein the mixed oxide exhibits a Zr/Ce atomic ratio of at least 1 and comprises a lanthanum oxide and a neodymium oxide.

19. The process for the manufacture of a catalyzed particulate filter, for the purpose of lowering the oxidation temperature of the particles of said filter, comprising the step of incorporating a mixed oxide of cerium and of zirconium which exhibits a Ce/Zr atomic ratio of at least 1 and which additionally comprises a praseodymium oxide, the porosity of this mixed oxide being such that at least 80% of the pore volume is contributed by pores with a diameter at least equal to 20 nm.

20. The process as claimed in claim 19, wherein the mixed oxide having a content of praseodymium oxide of at least 10%.

21. The process as claimed in claim 19, wherein the mixed oxide has a content of praseodymium oxide of between 10% and 35%.

22. The process as claimed in claim 13, wherein the zirconium oxide further comprises a praseodymium oxide.

23. The process according to claim 13, wherein the oxide is milled to a particle size of between 0.5 μm and 1.5 μm.

24. The process according to claim 14, wherein the mixed oxide is milled to a particle size of between 0.5 μm and 1.5 μm.

25. The process according to claim 13, wherein the oxide has a porosity such that at least 85% of the pore volume is contributed by pores with a diameter at least equal to 20 nm.

26. The process according to claim 14, wherein the mixed oxide has a porosity such that at least 85% of the pore volume is contributed by pores with a diameter at least equal to 20 nm.

27. The process according to claim 13, wherein, wherein the oxide exhibits a distribution in the pores such that the pore volume contributed by the pores having a diameter of between 20 nm and 100 nm constitutes at least 10%, optionally at least 30%, of the total pore volume.

28. The process according to claim 14, wherein, wherein the mixed oxide exhibits a distribution in the pores such that the pore volume contributed by the pores having a diameter of between 20 nm and 100 nm constitutes at least 10%, optionally at least 30%, of the total pore volume.

29. A catalyzed particulate filter, made by the process as defined in claim 13.

30. A catalyzed particulate filter, made by the process as defined in claim 14.
